(19) United States
(12) Patent Application Publication
(10) Pub. No.: US 2011/0305970 A1
(43) Pub. Date: Dec. 15, 2011

(54) CHEMICALLY LINKED HYDROGEL MATERIALS AND USES THEREOF IN ELECTRODES and/or ELECTROLYTES IN ELECTROCHEMICAL ENERGY DEVICES

(76) Inventors: Yogeshwar Sahai, Powell, OH (US); Nurul A. Choudhury, Columbus, OH (US); Rudolph G. Buchheit, Columbus, OH (US)

(21) Appl. No.: 12/944,067

(22) Filed: Nov. 11, 2010

Related U.S. Application Data
(60) Provisional application No. 61/353,734, filed on Jun. 11, 2010.

(51) Int. Cl. H01M 8/10; H01M 4/583; H01G 9/00; H01M 4/62; B01J 31/06; H01G 9/155; H01M 4/00; H01M 4/38

(52) U.S. Cl. 429/492; 429/523; 429/532; 429/531; 429/525; 429/209; 502/159; 502/1; 361/502; 361/500

(57) ABSTRACT

A chemically linked catalyst-binder hydrogel material comprised of a water-insoluble chemical hydrogel is useful in, for example, fuel cells, batteries, electrochemical supercapacitors, semi-fuel cells etc. The water-insoluble chemical hydrogel is prepared by a chemical cross-linking reaction between a polymer (such as PVA or chitosan or gelatin) and an aqueous cross-linking agent such as glutaraldehyde, which is catalyzed by protic acid under ambient conditions of temperature and pressure.

### CROSS-REFERENCE TO RELATED APPLICATIONS

This application claims the benefit of U.S. Provisional Application Ser. No. 61/353,734 filed Jun. 11, 2010, the entire disclosure of which is expressly incorporated herein by reference.

### STATEMENT REGARDING FEDERALLY SPONSORED RESEARCH

This invention was not made with any Federal Government support and the Federal Government has no rights in this invention.

### TECHNICAL FIELD AND INDUSTRIAL APPLICABILITY OF THE INVENTION

This invention is directed to chemically linked catalyst-binder hydrogel materials useful for electrodes in fuel cells, batteries, electrochemical supercapacitors, as well as semi-fuel cells, methods for making and using the same.

### BACKGROUND

Fuel cells constitute an attractive class of renewable and sustainable energy sources, alternative to conventional energy sources such as petroleum oil and natural gas that have finite reserves. Energy generation from petroleum oil and natural gas through combustion in a heat engine being subject to Carnot Cycle limitation is inherently inefficient and is accompanied with environmental pollution. In contrast, a fuel cell is intrinsically energy efficient, non-polluting, silent, and reliable.

In some situations, a fuel cell can be a low temperature device that provides electricity instantly upon demand, and exhibits a long operating life. Energy efficiencies of about 50-70% can be achieved with fuel cells. Fuel cells combine the advantages of both combustion engines and batteries, at the same time eliminating the major drawbacks of both. Similar to a battery, a fuel cell is an electrochemical energy device that converts chemical energy into electricity; and akin to a heat engine, a fuel cell supplies electricity as long as fuel and oxidant are supplied to it.

Among the various types of fuel cells developed so far, polymer electrolyte fuel cells (PEFCs) have the advantage of high power densities at relatively low operating temperatures (≦80° C.) and are, therefore, considered promising power sources for applications in portable and residential devices as well as in electric vehicles. Research and development on PEFCs using hydrogen as the fuel have progressed significantly but their successful commercialization is restricted because of the high costs of both the platinum electrodes and the perfluorinated ion-exchange membranes (i.e., Nafion®) that are needed. Another drawback in such PEFCs is that, during continued use of the PEFC, there is a “poisoning” of the platinum electrodes by carbon monoxide that is generated when using a reformer in conjunction with the PEFC. Still another drawback is the concern in the industry and by others regarding the safety of the PEFCs, as well as storage efficiency of flammable hydrogen gas.

In order to overcome these drawbacks, some have used liquid methanol instead to fuel PEFCs. Direct use of liquid fuel in a PEFC simplifies the engineering issues, thereby driving down the system complexity and hence cost. PEFCs that are fed with methanol as fuel are referred to as direct methanol fuel cells (DMFCs). However, DMFCs also have limitations such as, for example: inefficient methanol electro-oxidation, low open circuit potential, and methanol crossover from anode to cathode compartment through the polymer electrolyte membrane (PEM).

Attempts to overcome the limitations arising from the use of methanol in DMFCs include the use of other hydrogen-containing materials such as borohydride compounds as fuel; for example, sodium borohydride (NaBH₄), which has a capacity value of 5.67 Ah g⁻¹ and a hydrogen content of 10.6 wt. %, is a better alternative to methanol as a fuel. A PEFC that utilizes a borohydride compound, usually sodium borohydride in aqueous alkaline medium, directly as a fuel is termed as direct borohydride fuel cell (DBFC).

In addition, an important component in any low operating-temperature fuel cell is the electrode binder that is used to keep the electrode material bound to a substrate, or current collector. In addition, the binders help in achieving high fuel cell performances by establishing three-point contact among reactant (fuel/oxidant), electrode catalyst and PEM in PEFCs. Perfluorosulfonic acid (Nafion®) and poly (tetrafluoroethylene) (PTFE) have been widely employed as electrode binders in various types of fuel cells. Nafion® binder is commercially available as a solution in a mixture of water and lower aliphatic alcohols. In certain situations, a catalyst ink with Nafion® binder is prepared with 2-propanol as solvent; however, the use of such solvent not only increases the cost of fuel cell technology, but also presents health hazards.

Although PTFE is a little less expensive than Nafion® binder, PTFE is a hydrophobic material and can only be used in the cathode of a PEFC that employs oxygen as oxidant. PTFE allows passage of oxygen to the cathode catalyst and at the same time avoiding accumulation of water leading to the flooding of the cathode.

Batteries are electrochemical energy storage devices that convert chemical energy into electrical energy and vice versa. Batteries have three major components, namely, a positive electrode, a negative electrode and an electrolyte. Batteries employ both aqueous and non-aqueous electrolytes in either liquid or solid state; the latter provide the advantages of compactness, reliability and freedom from any leakage of liquid. The aqueous liquid electrolyte may be either acidic or alkaline in nature. Both the electrodes in a battery contain a polymer-based binder that binds the electro-active material to the electrode substrate. Some of batteries employ aqueous acidic environments whereas some other batteries employ aqueous alkaline environments.

In the electrodes of batteries, oxidation and reduction reactions take place during charging and discharging processes. Batteries are classified as primary or non-rechargeable and secondary or rechargeable. One example of a primary battery is a zinc-carbon battery. Examples of secondary batteries include lead-acid batteries and nickel-metal hydride batteries, etc.

Electrochemical supercapacitors (ESs) are electrochemical power systems with highly reversible charge-storage and delivery capabilities. ESs have properties complementary to secondary batteries and find usage in hybrid energy systems for electric vehicles, heavy-load starting assist for diesel locomotives, utility load leveling, military and medical applications. Depending on the charge-storage mechanism, an ES is classified as an electrical double-layer capacitor (EDLC) or a pseudocapacitor. The higher energy density of EDLCs, as compared to dielectric capacitors, is primarily due to the large surface area of the electrode materials, usually comprising activated carbons, aerogel or xerogel carbons as also the carbon nanotubes. EDLCs have several advantages over secondary batteries, namely faster charge-discharge, longer cycle-life (>100,000 cycles) and higher power density.

Pseudocapacitors are also called redox capacitors because of the involvement of redox reactions in the charge-storage and delivery processes. Energy storage mechanisms in pseudocapacitors involve fast Faradaic reactions, such as underpotential deposition, intercalation or redox processes occurring at or near a solid electrode surface at an appropriate potential. Redox processes often occur in conducting polymers and metal oxides making them attractive materials for pseudocapacitors. ESs employ both aqueous and non-aqueous electrolytes in either liquid or solid state; the latter provide the advantages of compactness, reliability and freedom from any leakage of liquid.

Semi-fuel cells are a class of electrochemical energy devices that employ an anode that is similar to a battery and a cathode that is similar to a fuel cell. The electrolyte in a semi-fuel cell is generally a neutral aqueous medium.

### SUMMARY OF THE INVENTION

In a first aspect, there is provided herein a fuel cell comprising: an anode, a cathode, and an electrolyte between the anode and the cathode. The anode has a first surface and second surface, and the anode is comprised of a substrate where at least the first surface of the anode substrate is at least partially coated and/or impregnated with a first anode ink comprising an anode catalyst, an anode catalyst support material such as high surface area carbon powder and a chemically linked catalyst-binder hydrogel material. The cathode has a first surface and a second surface, and the cathode is comprised of a substrate where at least the first surface of the cathode substrate is at least partially coated and/or impregnated with a second cathode ink comprising a cathode catalyst, a cathode catalyst support material such as high surface area carbon powder, and a chemically linked catalyst-binder hydrogel material.

In certain embodiments, the first chemically linked catalyst-binder hydrogel material that is capable of binding an anode catalyst material to the anode substrate; and wherein the second chemically linked catalyst-binder hydrogel material is capable of binding a cathode catalyst material to the cathode substrate.

In certain embodiments, the first and second chemically linked catalyst-binder hydrogel materials maintain thermal stability of the fuel cell at operating temperatures of about ≦100° C.

In certain embodiments, the chemically linked catalyst-binder hydrogel material is prepared by chemical cross-linking of at least one type of polymer that is soluble in aqueous acetic acid or water with a water-soluble cross-linking agent,

In certain embodiments, fuel cell comprises a direct borohydride fuel cell.

In certain embodiments, the anode has been formed by:

i) providing an aqueous suspension comprised of an anode catalyst;

ii) providing an aqueous mixture of a polymer and a cross-linking agent;

iii) adding the mixture of ii) to the suspension of i) to form an anode catalyst ink;

iv) at least partially coating the substrate with the anode catalyst ink of iii); and,

v) exposing the coated substrate of iv) to a protic acid catalyst that is capable of causing cross-linking of the polymer and the cross-linking agent such that the first chemically linked catalyst-binder hydrogel material is formed;

wherein the anode catalyst is at least partially contained within the chemically linked catalyst-binder hydrogel material.

In certain embodiments, the anode catalyst comprises AB₅ alloy and carbon powder, the polymer comprises PVA, the cross-linking agent comprises glutaraldehyde, and the protic acid catalyst comprises one or more of: HCl, HClO₄, H₂SO₄, HClO₃ or acetic acid.

In certain embodiments, the cathode has been formed by:

i) providing an aqueous suspension comprised of a cathode catalyst;

ii) providing an aqueous mixture of a polymer and a cross-linking agent;

iii) adding the mixture of ii) to the suspension of i) to form a cathode catalyst ink;

iv) at least partially coating the substrate with the cathode catalyst ink of iii); and,

v) exposing the coated substrate of iv) to a protic acid catalyst that is capable of causing cross-linking of the polymer and the cross-linking agent such that the second chemically linked catalyst-binder hydrogel material is formed;

wherein the cathode catalyst is at least partially contained within the second chemically linked catalyst-binder hydrogel material.

In certain embodiments, the cathode catalyst comprises a carbon-supported palladium (Pd/C), the polymer comprises PVA, the cross-linking agent comprises glutaraldehyde, and the protic acid catalyst comprises one or more of: HCl, HClO₄, H₂SO₄, HClO₃ or acetic acid.

In certain embodiments, the cross-linking reaction takes place at ambient conditions of temperature and pressure.

In certain embodiments, wherein the anode has been formed by:

i) providing an aqueous suspension comprised of an anode catalyst;

ii) providing a solution of chitosan dissolved in an aqueous protic acid;

iii) adding the solution of ii) to the suspension of i) to form an anode catalyst ink;

iv) at least partially coating the substrate with the anode catalyst ink of iii); and,

v) exposing the coated substrate of iv) to an aqueous solution of a cross-linking agent,

wherein the chitosan is cross-linked with the cross-linking agent such that the first chemically linked catalyst-binder hydrogel material is formed; wherein the anode catalyst is at least partially contained within the first chemically linked catalyst-binder hydrogel material.

In certain embodiments, the anode catalyst comprises AB₅ alloy and carbon powder, and the cross-linking agent comprises glutaraldehyde.

In certain embodiments, the cathode has been formed by:

i) providing an aqueous suspension comprised of a cathode catalyst;

ii) providing a solution of chitosan dissolved in an aqueous protic acid;

iii) adding solution of ii) to the suspension of i) to form a cathode catalyst ink;

iv) at least partially coating the substrate with the cathode catalyst ink of iii); and,

v) exposing the coated substrate of iv) to an aqueous solution of a cross-linking agent, wherein the chitosan is cross-linked with the cross-linking agent such that the second chemically linked catalyst-binder hydrogel material is formed;

wherein the cathode catalyst is at least partially contained within the second chemically linked catalyst-binder hydrogel material.

In certain embodiments, the cathode catalyst comprises a carbon-supported palladium (Pd/C), and the cross-linking agent comprises glutaraldehyde.

In certain embodiments, the cross-linking reaction takes place at ambient conditions of temperature and pressure.

In certain embodiments, at least one of the anode substrate and cathode substrate are comprised of a carbon paper or carbon cloth.

In another aspect, there is provided herein a method of generating electricity comprising the fuel cell as described herein.

In another aspect, there is provided herein a power supply device comprising the fuel cell as described herein.

In another aspect, there is provided herein a fuel cell comprising: an anode, a cathode, and an electrolyte between the anode and the cathode. The anode has a first surface and second surface, and the anode is comprised of a substrate where at least the first surface of the anode substrate is at least partially coated and/or impregnated with a first chemically linked catalyst-binder hydrogel material that encompasses the anode catalyst. The cathode has a first surface and a second surface, and the cathode is comprised of a substrate where at least the first surface of the cathode substrate is at least partially coated and/or impregnated with a second chemically linked catalyst-binder hydrogel material that encompasses the cathode catalyst. The electrolyte comprises a mixture of a polymer and a crosslinking agent which has been exposed to an acid catalyst that is capable of causing cross-linking of the polymer and the cross-linking agent such that a chemically linked hydrogel electrolyte material is formed.

In another aspect, there is provided herein a chemically linked catalyst-binder hydrogel material, prepared by chemical cross-linking a polymer in aqueous medium and a water-soluble cross-linking agent that is catalyzed by a protic acid.

In certain embodiments, the polymer comprises PVA, the water-soluble cross-linking agent comprises glutaraldehyde, and the protic acid catalyst comprises one or more of: HCl, HClO₄, H₂SO₄, HClO₃ or acetic acid.

In another aspect, there is provided herein a material comprising a PVA chemically linked catalyst-binder hydrogel material that is stable in acidic environments.

In another aspect, there is provided herein a use of the chemically linked catalyst-binder hydrogel material in fuel cells that employ an acidic environment.

In another aspect, there is provided herein a material comprising a PVA chemically linked catalyst-binder hydrogel material that is stable in alkaline environments.

In another aspect, there is provided herein a use of the chemically linked catalyst-binder hydrogel material in fuel cells that employ an alkaline environment.

In certain embodiments, the polymer comprises chitosan dissolved in aqueous acetic acid, the water-soluble cross-linking agent comprises glutaraldehyde, and the acid catalyst comprises one or more of: HCl, HClO₄, H₂SO₄, HClO₃ or acetic acid.

In another aspect, there is provided herein a material comprising a chitosan chemically linked catalyst-binder hydrogel material that is stable in acidic environments.

In another aspect, there is provided herein a use of the chemically linked catalyst-binder hydrogel material in fuel cells that employ an acidic environment.

In another aspect, there is provided herein a material comprising a chitosan chemically linked catalyst-binder hydrogel material that is stable in alkaline environments.

In another aspect, there is provided herein a use of the chemically linked catalyst-binder hydrogel material in fuel cells that employ an alkaline environment.

In another aspect, there is provided herein a method of making a chemically linked catalyst-binder hydrogel material, comprising:

cross-linking a polymer in aqueous medium with an aqueous cross-linking agent in the presence of an aqueous protic acid catalyst under ambient conditions of temperature and pressure.

In certain embodiments, the method comprises: cross-linking a PVA polymer in an aqueous solution of acetic acid with aqueous glutaraldehyde cross-linking agent under ambient conditions of temperature and pressure.

In certain embodiments, the method comprises: cross-linking chitosan in an aqueous solution of acetic acid with aqueous glutaraldehyde cross-linking agent under ambient conditions of temperature and pressure.

In another aspect, there is provided herein a chemically linked hydrogel electrolyte material, comprising:

a mixture of a polymer and a crosslinking agent, which has been exposed to an acid catalyst that is capable of causing cross-linking of the polymer and the cross-linking agent such that the chemically linked hydrogel electrolyte material is formed.

In certain embodiments, the polymer comprises PVA, the cross-linking agent comprises glutaraldehyde, and the protic acid catalyst comprises one or more of: HCl, HClO₄, H₂SO₄, and HClO₃.

In another aspect, there is provided herein a method for making a chemically linked hydrogel electrolyte material, comprising:

i) providing a mixture of a polymer and a crosslinking agent;

ii) forming a film from the mixture of i);

iii) exposing the film of ii) to an acid catalyst that is capable of causing cross-linking of the polymer and the cross-linking agent such that the chemically linked hydrogel electrolyte membrane material is formed;

wherein the anode catalyst is at least partially contained within the chemically linked catalyst-binder hydrogel material.

In another aspect, there is provided herein an electrochemical energy storage device having: a positive electrode, a negative electrode, and an electrolyte between the positive electrode and the negative electrode, and a chemically linked hydrogel as an electrode binder.

In certain embodiments, the device comprises a battery that employs either aqueous acidic or alkaline media.

In another aspect, there is provided herein an electrochemical supercapacitor having: two similar electrodes, and an electrolyte between the two electrodes.

wherein each of the two electrodes is comprised of a substrate that has a first surface and a second surface,

at least the first surface of each of the substrate is at least partially coated and/or impregnated with an electrode material that comprises a high surface area material and a chemically linked catalyst-binder hydrogel material.

In another aspect, there is provided herein an electrochemical supercapacitor having: two dissimilar electrodes, and an electrolyte between the two electrodes, wherein each of the two electrodes is comprised of a substrate that has a first surface and a second surface, at least the first surface of each of the substrates is at least partially coated and/or impregnated with an electrode material that comprises a high surface area material and a chemically linked catalyst-binder hydrogel material.

In certain embodiments, the high surface area material comprises one or more of activated carbons, aerogels, xerogel carbons, and carbon nanotubes.

In certain embodiments, the electrode material comprises an electro-active material and a chemically linked catalyst-binder hydrogel material.

In another aspect, there is provided herein an electrochemical supercapacitor having: two similar electrodes, and an electrolyte between the two electrodes, wherein each of the two electrodes is comprised of a substrate that has a first surface and a second surface, at least the first surface of each of the substrates is at least partially coated and/or impregnated with an electrode material that comprises an electro-active material and a chemically linked catalyst-binder hydrogel material.

In another aspect, there is provided herein an electrochemical supercapacitor having: two dissimilar electrodes, and an electrolyte between the two electrodes, wherein each of the two electrodes is comprised of a substrate that has a first surface and a second surface, at least the first surface of each of the substrates is at least partially coated and/or impregnated with an electrode material that comprises an electro-active material and a chemically linked catalyst-binder hydrogel material.

In certain embodiments, the electro-active material comprises one or more of conducting polymers and metal oxides.

In another aspect, there is provided herein a semi-fuel cell comprised of an anode that is capable of electro-oxidation giving rise to electrons and ionic by-product; and a cathode comprised of a substrate that has a first surface and a second surface, wherein at least the first surface of the cathode substrate is at least partially coated and/or impregnated with an electro-active material that is capable of electrochemically reducing hydrogen peroxide.

In another aspect, there is provided herein a semi-fuel cell comprised of an anode that is capable of electro-oxidation giving rise to electrons and ionic by-product; and a cathode comprised of an electro-catalyst and a chemically linked catalyst-binder hydrogel material.

Other systems, methods, features, and advantages of the present invention will be or will become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The patent or application file contains one or more drawings executed in color and/or one or more photographs. Copies of this patent or patent application publication with color drawing(s) and/or photograph(s) will be provided by the Patent Office upon request and payment of the necessary fee.

FIG. 1A: Chemical cross-linking reaction between PVA and glutaraldehyde in the presence of a protic acid catalyst resulting in the formation of chemically linked catalyst-binder hydrogel material.

FIG. 1B: Chemical cross-linking reaction between chitosan and formaldehyde resulting in the formation of chitosan chemical hydrogel.

FIG. 1C: Chemical cross-linking reaction between gelatin and glutaraldehyde resulting in the formation of gelatin chemical hydrogel

FIG. 2: Photograph showing a PVA chemically linked catalyst-binder hydrogel material, along with a Teflon®-coated magnetic stirring bar in a glass beaker lying sideways on a horizontal surface.

FIG. 3: Graphs showing electrochemical performances of direct borohydride fuel cells employing: PVA hydrogel membrane electrolyte (PHME) as a combined electrolyte-separator, and having either a chemically linked catalyst-binder hydrogel material (PVA chemical hydrogel binder); or, Nafion® as a binder.

FIG. 4: Graphs showing electrochemical performances of direct borohydride fuel cells employing: Nafion® membrane electrolyte (NME) as a combined electrolyte-separator, and having either a chemically linked catalyst-binder hydrogel material (PVA chemical hydrogel binder); or, Nafion® as a binder.

FIG. 5: Graph showing electrochemical performance durability of direct borohydride fuel cells employing PVA chemical hydrogel binder-based electrodes and NME as electrolyte-cum-separator.

FIG. 6: Photograph showing a chitosan chemically linked catalyst-binder hydrogel material, along with a Teflon®-coated magnetic stirring bar in an inverted glass beaker.

FIG. 7: Graphs showing electrochemical performance data for a direct borohydride fuel cell employing: a chitosan chemical hydrogel as electrode binder and PHME as well as NME as electrolytes-cum-separators.

FIG. 8: Schematic illustration of a fuel cell.

### DETAILED DESCRIPTION

Throughout this disclosure, various publications, patents and published patent specifications are referenced by an identifying citation. The disclosures of these publications, patents and published patent specifications are hereby incorporated by reference into the present disclosure to more fully describe the state of the art to which this invention pertains.

Hydrogels are 3-dimensional polymeric networks that absorb and retain in their polymeric matrices many times of water than their actual dry weight. The 3-dimensional network formation and their insolubility in the parent solution are due to the presence of chemical cross-links or physical entanglements. Unlike the covalent cross-linking points in chemical hydrogels formed by the reaction between the polymer and a cross-linking reagent, physical hydrogels are formed through association of several laterally associated polymer helices in extended junction zones, wherein the hydrogel network is stabilized by physical entanglements, electrostatic attractive forces or hydrogen bonding; physical hydrogels are thermally reversible and can be viewed as viscoelastic solids.

In particular, polymer hydrogels are solid materials that contain large volume of water inside their polymer matrixes. Polymer hydrogels can be used as ion-conduction media and hence as solid electrolytes in electrochemical devices. Polymer hydrogel electrolytes provide the advantages of both liquid electrolytes (such as high ionic conductivity (10⁻³-10⁻¹ S cm⁻¹) as compared to solid polymer electrolytes (10⁻⁸-10⁻⁷ S cm⁻)) and solid electrolytes (such as leak-proof nature as well as reliability).

Described herein is a fuel cell that has a novel and cost-effective electrode material that comprised of a chemically linked catalyst-binder hydrogel material. Thus, as described herein, the chemical hydrogel material acts as a as catalyst binder in both the anode and the cathode of fuel cells. That is, the chemical hydrogel material is not an additional component in a fuel cell, but is present as a cost-effective substitute for a commercial catalyst binder.

The present invention is not limited to electrodes of fuel cells that employ liquid reactants. In contrast, the present invention describes that the chemically linked catalyst-binder hydrogel materials may be used in a variety of fuel cells as well as in other electrochemical energy systems such as batteries and electrochemical supercapacitors. For ease of illustration, the following description is written to specifically describe fuel cells, and in particular, direct borohydride fuel cells. It is to be understood, however, that other uses are within the contemplated scope of the present invention.

The fuel cell described herein can be considered to be a low-operating temperature fuel cell with operational temperature ≦100° C., which allows the chemical hydrogel to maintain its thermal stability.

In certain embodiments the water-insoluble chemical hydrogel is comprised of a synthetic water-soluble polymer, such as polyvinyl alcohol (PVA). In other embodiments, the water-insoluble chemical hydrogel is comprised of a chitosan material which can be generally described as a linear polysaccharide having randomly distributed β-(1-4)-linked D-glucosamines (deacetylated units) and N-acetyl-D-glucosamines (acetylated units).

The water-insoluble electrode binder material described herein is especially useful in direct borohydride fuel cells that use Misch-metal-based AB₅ alloy as anode, carbon-supported palladium as cathode and PVA chemical hydrogel as well as Nafion®-117 membranes as electrolytes-cum-separators.

In one embodiment, the PVA chemical hydrogel is prepared by a chemical cross-linking reaction between aqueous PVA and an aqueous cross-linking material, such as glutaraldehyde, which is catalyzed by a protic acid under ambient conditions of temperature and pressure.

In another embodiment, the chitosan chemical hydrogel (CCH) is prepared by a chemical cross-linking reaction between chitosan dissolved in aqueous acetic acid and aqueous glutaraldehyde under ambient conditions of temperature and pressure.

The water-insoluble chemical hydrogel material described herein can be prepared by chemical cross-linking of polymers (such as chitosan, PVA, gelatin etc.) that are soluble in aqueous acetic acid or water with a water-soluble cross-linking agent, such as glutaraldehyde, formaldehyde etc. In certain embodiments, the cross-linking reaction is catalyzed by a protic acid such as HCl, HClO₄, H₂SO₄, HClO₃ etc.

It is to be noted that the water absorption and retention capacity of PVA chemical hydrogel or chitosan chemical hydrogel is larger than that of other polymer binder materials. Another advantage is that the water-insoluble chemical hydrogel materials provide a better medium for ion conduction than previously used binder materials. In addition, the hydrogel binder-based fuel cells are shown herein as exhibiting better cell performance than other PEFCs.

In one embodiment, a PVA chemical hydrogel binder-based catalyst ink is prepared with water as the suspension medium. This is a great improvement over Nafion® binder-based catalyst inks, which must be prepared with 2-propanol as the suspension medium. Thus, in the invention described herein, use of water as medium for the preparation of the catalyst ink in the making of the chemically linked catalyst-binder hydrogel materials improves both the cost-effectiveness and the environment-friendliness of fuel cells.

Chemically linked catalyst-binder hydrogel materials made with either PVA or chitosan are shown herein as having electrochemical performances that are favorably comparable to DBFCs which use Nafion® as an electrode binder.

Thus, in a broad aspect there is provided herein a fuel cell having: i) an anode comprised of a chemically linked catalyst-binder hydrogel material that is capable of binding an anode catalyst to an anode substrate; ii) a cathode comprised of chemically linked catalyst-binder hydrogel material that is capable of binding a cathode catalyst to the cathode substrate; and, iii) an electrolyte.

The chemically linked catalyst-binder hydrogel materials described herein can be used where one or both of the anode substrate and cathode substrate are comprised of carbon paper materials or carbon cloth materials.

In certain embodiments, the chemically linked catalyst-binder hydrogel materials described herein not only bind the catalyst to the catalyst substrate, but also enhance the fuel cell performance by establishing a three-point contact among: 1) the reactant (fuel/oxidant), 2) the electro-catalyst, and 3) the electrolyte in the fuel cells. That is, the chemically linked catalyst-binder hydrogel materials are comprised of 3-dimensional polymeric matrix networks that absorb and retain many times more the amount of water than the chemical hydrogels' actual dry weight. The 3-dimensional network formation and its insolubility in the parent solution are due to the presence of chemical cross-links.

In another broad aspect, there is provided herein a method of making a chemically linked catalyst-binder hydrogel material, which method includes a chemical cross-linking of an aqueous solution of the PVA with aqueous glutaraldehyde in the presence of a protic acid catalyst under ambient conditions of temperature and pressure.

In another broad aspect, there is provided herein a method of making a chemically linked catalyst-binder hydrogel material, which method includes chemical cross-linking of chitosan dissolved in an aqueous acetic acid solution with aqueous solution of glutaraldehyde under ambient conditions of temperature and pressure.

The chemically linked catalyst-binder hydrogel materials are useful as binder materials in a fuel cell and aid in keeping the anode material and the cathode material bound to the current collectors of fuel cells.

The chemically linked catalyst-binder hydrogel materials are also useful as binder materials in fuel cells and aid in achieving high fuel cell performances by establishing a three-point contact among the reactant (fuel/oxidant), the electrode catalyst, and the polymer electrolyte membrane.

In another broad aspect, there is provided herein a method of preparing the chemically linked catalyst-binder hydrogel materials using a cost-effective and environmentally safe aqueous manufacturing method.

In another broad aspect, there is provided herein a direct borohydride fuel cell comprised of a chemically linked catalyst-binder hydrogel material that acts as a medium, which conducts fuel and its electro-oxidation product, oxidant and its electro-reduction product as well as various ionic species.

The inventors herein have now discovered that chemically linked catalyst-binder hydrogel materials are stable in both acidic and alkaline aqueous solutions, which provides a distinct advantage where the chemically linked catalyst-binder hydrogel material can be used as electrode binder in a variety of fuel cells, as well as being useful in batteries, electrochemical supercapacitors, and other electrochemical energy devices.

The chemically linked catalyst-binder hydrogel materials are especially useful to fabricate both anodes and cathodes in low-operating temperature fuel cells. For example, in specific embodiments, the chemically linked catalyst-binder hydrogel materials are useful components of low operating-temperature (≦100° C.) fuel cells such as polymer electrolyte fuel cells (PEFCs), direct methanol fuel cells (DMFCs), direct borohydride fuel cells (DBFCs), alkaline fuel cells (AFCs), phosphoric acid fuel cells (PAFCs), and the like.

The chemically linked catalyst-binder hydrogel materials not only keep the electrode materials bound to the current collectors making up the fuel cell, but also help in achieving high fuel cell performances by establishing a three-point contact among the reactant (fuel/oxidant), the electrode catalyst and the electrolyte in such fuel cells. For example, it is shown herein that water absorption and retention capacity of the PVA-based chemically linked catalyst-binder hydrogel materials and the chitosan-based chemically linked catalyst-binder hydrogel materials are greater than that of the polymers generally employed as electrode binder in fuel cells.

Also, in certain embodiments, the chemically linked catalyst-binder hydrogel materials can be used as conduction media (i.e., as an electrolyte) for all water-soluble species such as ions and molecules such as hydrogen peroxide, methanol, ethanol, propanol and the like.

An electrode in an electrochemical energy device generally comprises an electro-active material, an electrically conducting high surface area support material such as carbon powder, a binder material, an electrically conducting substrate on which the electro-active material is pasted with the help of the binder, and an electrical lead that helps in conduction of electricity to the external circuit.

The electro-active material may be an inert catalyst such as platinum, palladium etc. on the surface of which a fuel or an oxidant undergoes electrochemical transformation resulting in generation of electricity. This is the case with most of fuel cells. In some electrochemical devices such as batteries and pseudo-capacitors, the electro-active material itself undergoes electrochemical changes during charging and discharging processes. Non-limiting examples of such electro-active materials include metal oxides, e. g., oxides of lead and manganese etc.

The electrically conducting support material such as high surface area carbon powder is mixed with the electro-active material to increase the electrochemical surface area of the latter. The electrically conducting electrode substrate is generally a carbon paper such as Toray carbon paper, a carbon cloth or a metallic mesh on which the mixture of electro-active material and the high surface area support material is bonded with the help of a binder material.

The electrode binder is a generally a polymer-based material that is capable of not only binding the electrode materials with the electrode substrate and keeping them intact but also acts as a conduction medium for fuel and its electro-oxidation product, oxidant and its electro-reduction product as well as various ionic species. The ionic species may be a fuel such as borohydride ion (BH₄⁻), an electro-oxidation product of fuel such as metaborate ion (BO₃⁻³), H⁺ (in PEFC and DMFC), or ions supporting electrolyte such as Na⁺, OH⁻, H⁺, SO₄²⁻ in DBFC. The OH⁻ in DBFC not only increases the chemical stability of BH₄⁻ fuel but also takes part in its electro-oxidation process. H⁺ in DBFC not only increases the chemical stability of H₂O₂ oxidant but also help in increasing the electrochemical performance output of DBFC by lowering pH of H₂O₂ oxidant.

Fuel Cells

In a first aspect, there is provided herein a fuel cell having: an anode, a cathode, and an electrolyte between the anode and the cathode.

The anode is comprised of a substrate that has a first surface and a second surface, where at least the first surface of the anode substrate is at least partially coated and/or impregnated with an anode material that comprises an anode catalyst and a first chemically linked catalyst-binder hydrogel material.

The cathode is comprised of a substrate that has a first surface and a second surface, where at least the first surface of the cathode substrate is at least partially coated and/or impregnated with a cathode material that comprises a cathode catalyst and a chemically linked catalyst-binder hydrogel material.

In certain embodiments, the anode catalyst is capable of electrochemically oxidizing a fuel; and the first chemically linked catalyst-binder hydrogel material is capable of binding the anode catalyst material to the anode substrate.

And, in certain embodiments, the cathode catalyst is capable of electrochemically reducing an oxidant, and the second chemically linked catalyst-binder hydrogel material is capable of binding the cathode catalyst material to the cathode substrate.

In certain embodiments, the fuel cell comprises a direct borohydride fuel cell (DBFC).

In certain embodiments, the anode has been formed by:

i) providing an aqueous suspension comprised of an anode catalyst;

ii) providing an aqueous mixture of a polymer and a cross-linking agent;

iii) adding the mixture of ii) to the suspension of i) to form an anode catalyst ink;

iv) at least partially coating the substrate with the anode catalyst ink of iii); and,

v) exposing the coated substrate of iv) to a protic acid catalyst that is capable of causing cross-linking of the polymer and the cross-linking agent such that the anode (comprised of the anode catalyst and the first chemically linked catalyst-binder hydrogel material) is formed;

wherein the anode catalyst is at least partially contained within the first chemically linked catalyst-binder hydrogel material.

In certain embodiments, the anode catalyst comprises AB₅ alloy, AB₂ alloy, transition metal catalysts such as nickel, cobalt etc., precious metals such as platinum, palladium, iridium etc., rare earth metals such as lanthanum series metals etc.; support material comprises high surface area carbon powder; the polymer comprises one or more of PVA chitosan, gelatin; the cross-linking agent comprises glutaraldehyde and formaldehyde; and the protic acid catalyst comprises one or more of: HCl, HClO₄, H₂SO₄, HClO₃, CH₃COOH, HF, HBr, HI, H₃PO₄, H₃SO₃, HCOOH.

In certain embodiments, the cathode has been formed by:

i) providing an aqueous suspension comprised of a cathode catalyst;

ii) providing an aqueous mixture of a polymer and a cross-linking agent;

iii) adding the mixture of ii) to the suspension of i) to form a cathode catalyst ink;

iv) at least partially coating the substrate with the cathode catalyst ink of iii); and,

v) exposing the coated substrate of iv) to a protic acid catalyst that is capable of causing cross-linking of the polymer and the cross-linking agent such that the cathode (comprised of the cathode catalyst and the second chemically linked catalyst-binder hydrogel material) is formed;

wherein the cathode catalyst is at least partially contained within the second chemically linked catalyst-binder hydrogel material.

In certain embodiments, wherein the cathode catalyst comprises a carbon-supported palladium (Pd/C), platinum, iridium, manganese oxide, lead oxide etc. either in unsupported form or supported on high surface area carbon powder, the polymer comprises one or more of PVA, chitosan, and gelatin; the cross-linking agent comprises glutaraldehyde, formaldehyde; and the protic acid catalyst comprises one or more of: HCl, HClO₄, H₂SO₄, HClO₃, HF, HBr, HI, H₃PO₄, H₃SO₃, HCOOH or CH₃COOH.

In certain embodiments, the cross-linking reaction takes place at ambient conditions of temperature and pressure.

In certain embodiments, the anode has been formed by:

i) providing an aqueous suspension comprised of an anode catalyst;

ii) providing a solution of chitosan dissolved in an aqueous protic acid;

iii) adding the solution of ii) to the suspension of i) to form an anode catalyst ink;

iv) at least partially coating the substrate with the anode catalyst ink of iii); and,

v) exposing the coated substrate of iv) to an aqueous solution of a cross-linking agent,

wherein chitosan is cross-linked with the cross-linking agent such that the anode (comprised of the anode catalyst and the first chemically linked catalyst-binder hydrogel material) is formed; and

wherein the anode catalyst is at least partially contained within the first chemically linked catalyst-binder hydrogel material.

In certain embodiments, the anode catalyst comprises AB₅ alloy and carbon powder, and the cross-linking agent comprises glutaraldehyde.

In certain embodiments, the cathode has been formed by:

i) providing an aqueous suspension comprised of a cathode catalyst;

ii) providing a solution of chitosan dissolved in an aqueous protic acid;

iii) adding the solution of ii) to the suspension of i) to form a cathode catalyst ink;

iv) at least partially coating the substrate with the cathode catalyst ink of iii); and,

v) exposing the coated substrate of iv) to an aqueous solution of a cross-linking agent,

wherein chitosan is cross-linked with the cross-linking agent such that the cathode (comprised of the cathode catalyst and the second chemically linked catalyst-binder hydrogel material) is formed;

wherein the cathode catalyst is at least partially contained within the second chemically linked catalyst-binder hydrogel material.

In certain embodiments, the cathode catalyst comprises a carbon-supported palladium (Pd/C), and the cross-linking agent comprises glutaraldehyde.

In certain embodiments, the cross-linking reaction takes place at ambient conditions of temperature and pressure.

In certain embodiments, at least one of the anode substrate and cathode substrate are comprised of a carbon paper or carbon cloth or metallic mesh.

In another aspect, there is provided herein a method of generating electricity comprising using the fuel cells as described herein.

In another aspect, there is provided herein a supply device comprising the fuel cells as described herein.

In another aspect, there is provided herein a fuel cell having an anode, a cathode, and a chemically linked hydrogel electrolyte membrane between the anode and the cathode.

The anode has a first surface and second surface, and is comprised of a substrate where at least the first surface of the anode substrate is at least partially coated and/or impregnated with the anode catalyst and the first chemically linked catalyst-binder hydrogel material.

The cathode has a first surface and a second surface, and is comprised of a substrate where at least the first surface of the cathode substrate is at least partially coated and/or impregnated with the cathode catalyst and the second chemically linked catalyst-binder hydrogel material.

The electrolyte is comprised of a mixture of a polymer and a crosslinking agent which has been exposed to an acid catalyst that is capable of causing cross-linking of the polymer and the cross-linking agent such that a chemically linked hydrogel electrolyte membrane material is formed.

Chemically Linked Catalyst-Binder Materials

In another broad aspect, there is provided herein chemically linked catalyst-binder hydrogel materials.

In certain embodiments, the chemically linked catalyst-binder hydrogel materials are prepared by chemical cross-linking an aqueous polymer and a water-soluble cross-linking agent in a protic acid catalyst.

In another aspect, there is provided herein the water-soluble polymer comprises PVA, the water-soluble cross-linking agent comprises glutaraldehyde, and the protic acid catalyst comprises one or more of: HCl, HClO₄, H₂SO₄, HClO₃ or CH₃COOH.

In another broad aspect, there is provided herein a material comprising a PVA chemically linked catalyst-binder hydrogel material that is stable in acidic environments.

In another broad aspect, there is provided herein use of the chemically linked catalyst-binder hydrogel material in fuel cells that employ an acidic environment.

In another broad aspect, there is provided herein a material comprising a PVA chemically linked catalyst-binder hydrogel material that is stable in alkaline environments.

In another broad aspect, there is provided herein use of the chemically linked catalyst-binder hydrogel material in fuel cells that employ an alkaline environment.

In another broad aspect, there is provided herein the polymer comprises water-soluble chitosan, the water-soluble cross-linking agent comprises glutaraldehyde, and the acid catalyst comprises one or more of: HCl, HClO₄, H₂SO₄, HClO₃, HF, HBr, HI, H₃PO₄, H₃SO₃, HCOOH or CH₃COOH.

In another broad aspect, there is provided herein a material comprising a chitosan chemically linked catalyst-binder hydrogel material that is stable in acidic environments.

In another broad aspect, there is provided herein use of the chemically linked catalyst-binder hydrogel material in fuel cells that employ an acidic environment.

In another broad aspect, there is provided herein a material comprising a chitosan chemically linked catalyst-binder hydrogel material that is stable in alkaline environments.

In another broad aspect, there is provided herein use of the chemically linked catalyst-binder hydrogel material in fuel cells that employ an alkaline environment.

In another broad aspect, there is provided herein a method of making a chemically linked catalyst-binder hydrogel material, comprising: cross-linking an aqueous polymer with an aqueous cross-linking agent in the presence of an aqueous protic acid catalyst under ambient conditions of temperature and pressure.

In certain embodiments, the method includes cross-linking PVA in an aqueous solution of acetic acid with aqueous glutaraldehyde cross-linking agent under ambient conditions of temperature and pressure.

In certain embodiments, the method includes cross-linking chitosan in an aqueous solution of acetic acid with aqueous glutaraldehyde cross-linking agent under ambient conditions of temperature and pressure.

In certain embodiments, the method includes cross-linking gelatin in an aqueous solution with an aqueous solution of glutaraldehyde cross-linking agent under ambient conditions of temperature and pressure.

In another broad aspect, the method includes cross-linking gelatin in an aqueous solution with an aqueous solution of formaldehyde cross-linking agent under ambient conditions of temperature and pressure.

In another broad aspect, there is provided herein a material comprising a gelatin chemically linked catalyst-binder hydrogel material that is stable in neutral aqueous environments.

In another broad aspect, there is provided herein use of the chemically linked catalyst-binder hydrogel material in electrochemical supercapacitors that employ a neutral electrolyte medium.

Electrolyte Materials

In another broad aspect, there is provided herein a chemically linked hydrogel electrolyte material, comprising:

a mixture of a polymer and a crosslinking agent, which has been exposed to an acid catalyst that is capable of causing cross-linking of the polymer and the cross-linking agent such that the chemically linked hydrogel electrolyte material is formed.

In another broad aspect, there is provided herein a method for making a chemically linked hydrogel electrolyte material, comprising:

i) providing a mixture of a polymer and a crosslinking agent;

ii) forming a film from the mixture of i);

iii) exposing the film of ii) to an acid catalyst that is capable of causing cross-linking of the polymer and the cross-linking agent such that the chemically linked hydrogel electrolyte material is formed.

In certain embodiments, the polymer comprises one or more of PVA and chitosan, the cross-linking agent comprises glutaraldehyde, and the protic acid catalyst comprises one or more of: HCl, HClO₄, H₂SO₄, and HClO₃.

In another broad aspect, there is provided herein a chemically linked hydrogel electrolyte material, comprising:

a mixture of a polymer and a crosslinking agent such that when the polymer and the cross-linking agent are mixed in aqueous medium, the chemically linked hydrogel electrolyte material is formed.

In another broad aspect, there is provided herein a method for making a chemically linked hydrogel electrolyte material, comprising:

i) providing a mixture of a polymer and a crosslinking agent;

ii) forming a film from the mixture of i); such that the chemically linked hydrogel electrolyte material is formed;

In certain embodiments, the polymer comprises a natural polymer, namely, gelatin and the cross-linking agent comprises glutaraldehyde, formaldehyde etc.

In another aspect, both gelatin and the cross-linking agents such as glutaraldehyde, formaldehyde and the like, are readily soluble in water.

Batteries

In another aspect, there is provided herein a battery that is an electrochemical energy storage device, which convert chemical energy into electrical energy and vice versa.

In another aspect, batteries are classified as primary or non-rechargeable and secondary or rechargeable. One non-limiting example of a primary battery includes a zinc-carbon battery. Non-limiting examples of secondary batteries include lead-acid batteries, and nickel-metal hydride batteries.

In another aspect, there is provided herein a battery having: a positive electrode, a negative electrode, and an electrolyte between the positive electrode and the negative electrode.

In another aspect, some of batteries employ aqueous acidic environment whereas other batteries employ aqueous alkaline environment.

In another aspect, chemically linked hydrogels based on PVA and chitosan can be employed as electrode binders in batteries that employ both aqueous acidic and alkaline media.

Electrochemical Supercapacitors

In a first aspect, there is provided herein an electrochemical supercapacitor having: two similar electrodes, and an electrolyte between the two electrodes. This type of electrochemical supercapacitors is called symmetrical supercapacitors.

In another aspect, there is provided herein an electrochemical supercapacitor having: two dissimilar electrodes, and an electrolyte between the two electrodes. This type of electrochemical supercapacitors is called asymmetrical supercapacitors.

In another aspect, electrochemical supercapacitors possess highly reversible charge-storage and delivery capabilities.

In another aspect, electrochemical supercapacitors possess very high cycle-life (>100,000 cycles) and very high power density.

In one aspect, each of the two electrodes is comprised of a substrate that has a first surface and a second surface, where at least the first surface of each of the electrode substrates is at least partially coated and/or impregnated with an electrode material that comprises a high surface area material such as activated carbons, aerogel or xerogel carbons as also the carbon nanotubes and a chemically linked catalyst-binder hydrogel material. Such electrochemical supercapacitors are called electrical double layer capacitors.

In another aspect, each of the two electrodes is comprised of a substrate that has a first surface and a second surface, where at least the first surface of each of the electrode substrates is at least partially coated and/or impregnated with an electrode material that comprises an electro-active material such as conducting polymers and metal oxides and a chemically linked catalyst-binder hydrogel material. Such electrochemical supercapacitors are called pseudocapacitors.

In another aspect, one of the electrodes is comprised of a substrate that has a first surface and a second surface, where at least the first surface of the electrode substrate is at least partially coated and/or impregnated with a an electrode material that comprises an electro-active material such as metal oxide and a chemically linked catalyst-binder hydrogel material. Such electrochemical supercapacitors are called pseudocapacitors.

Semi Fuel Cells

In a first aspect, semi-fuel cells are a class of electrochemical energy devices that employ an anode similar to a battery and a cathode similar to a fuel cell.

In another aspect, a semi-fuel cell is generally used as a source of energy in under-water applications where free convection of air is limited.

In another aspect, electrolyte in a semi-fuel cell is generally a neutral aqueous medium comprising sea-water that contains dissolved salts, which contribute to the ionic conductivity in the device.

In another aspect, the anode of a semi-fuel cell is comprised of a metal such as aluminum, zinc etc. that is capable of electro-oxidation giving rise to electrons and ionic by-product.

In another aspect, the anode of a semi-fuel cell is comprised of a metal such as aluminum, zinc etc. that gradually gets consumed during operation of the device.

In another aspect, a semi-fuel cell is one-time usable energy device that supplies energy as long as the anode metal is capable of supplying electrons by self ionization/dissolution and the cathode is supplied with hydrogen peroxide.

In another aspect, the cathode is comprised of a substrate that has a first surface and a second surface, where at least the first surface of the cathode substrate is at least partially coated and/or impregnated with a first, or an electrode material that comprises an electro-active material that is capable of electrochemically reducing hydrogen peroxide. Such materials include platinum, iridium, lead oxide, and the like.

In another aspect, the cathode comprises an electro-catalyst and a chemically linked catalyst-binder hydrogel material.

The present invention is further defined in the following Examples, in which all parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. All publications, including patents and non-patent literature, referred to in this specification are expressly incorporated by reference. The following examples are intended to illustrate certain preferred embodiments of the invention and should not be interpreted to limit the scope of the invention as defined in the claims, unless so specified.

### EXAMPLE A

### EXAMPLE A-1

Preparation of PVA Solution

An aqueous solution of polyvinyl alcohol (PVA) (0.05 or 0.1 g mL⁻¹) was prepared by adding the required amount of PVA (95% hydrolyzed, MW: 95000, Across Organics) in a certain volume of de-ionized (DI) water in a glass beaker covered with a Petridis and magnetically stirring the contents in a boiling water bath for 12 h.

### EXAMPLE A-2

Preparation of PVA and Glutaraldehyde Solution Mixture

A certain volume of a 0.05 or 0.1 g mL⁻¹ aqueous solution of PVA was mixed with an optimized volume of 25% aqueous solution of glutaraldehyde (25% aq. Solution, Alfa Aesar) and the contents were stirred magnetically at ambient conditions of temperature and pressure for 12 hours.

In one embodiment, 20 mL of 0.05 g mL⁻¹ or 10 mL of 0.1 g mL⁻¹ aqueous solution of PVA was mixed thoroughly with 0.2 mL of 25% aqueous glutaraldehyde by stirring magnetically for 12 hours at ambient temperature. The mixture was allowed to remain still for 12 hours in order to allow the air bubbles to disappear from the viscous solution.

### EXAMPLE A-3

Preparation of Nafion® Binder-Based Electrodes and Preparation of Water-Insoluble Chemical Hydrogel Binder-Based Electrodes (Anode and Cathode)

Anode Catalyst Ink

To prepare the anode catalyst ink, a desired amount of an AB₅ alloy powder of weight percentage composition La_{10.5}Ce_{4.3}Pr_{0.5}Nd_{1.4}Ni_{60.0}Co_{12.7}Mn_{5.9}Al_{4.7} (Ovonic Battery Company) was mixed thoroughly with 10 wt. % Vulcan XC 72® carbon powder in a glass vial. To this mixture, an adequate quantity of water was added and the suspension was agitated in an ultrasonic water bath (Bransonic® ultrasonic cleaner) for 2 hours.

Subsequently, a desired volume of Nafion® (5 wt. % solution, Ion Power Inc.) binder or a desired volume the PCH binder comprising an optimized aqueous solution mixture of PVA (0.05 g mL⁻¹) and glutaraldehyde (25%), as prepared by a procedure described in Example A-2 above, was added drop wise to the suspension of AB₅ alloy and Vulcan XC 72® carbon in water with ultrasonic agitation continued for another 2 hours. The loadings of AB₅ alloy, and Nafion®, as well as PCH binders, in each anode were about 30 mg cm⁻², and 5 wt. %, respectively, which were kept same.

Cathode Catalyst Ink

The cathode catalyst ink was prepared following a similar procedure, in which a quantity of 10 wt. % carbon-supported palladium (Pd/C) was mixed with an appropriate volume of water in a glass vial and the suspension was ultrasonically agitated for 2 hours.

Subsequently, a desired volume of Nafion® (5 wt. % solution, Ion Power Inc.) binder or a desired volume of PCH binder comprising an optimized aqueous solution mixture of PVA (0.05 g mL⁻¹) and glutaraldehyde (25%), as prepared by a procedure described in Example A-2 above, was added drop wise to the aqueous suspension of Pd/C with ultrasonic agitation continued for another 2 hours. The loadings of Pd, and Nafion®, as well as PCH binders, in each cathode were about 1 mg cm⁻², and 20 wt. %, respectively, which were kept identical in all the membrane electrode assemblies (MEAs) studied.

Anodes and Cathodes

The anode or cathode catalyst ink, thus prepared, was pasted on a pre-weighed carbon cloth substrate (Zorflex® Activated Carbon Cloth, FM 10, Chemviron Carbon/Calgon Carbon Corporation) with a paint brush and the catalyst ink-coated carbon cloth was dried inside a forced air-convection oven at room temperature.

Finally, each of the dried PCH binder-based catalyst ink-coated carbon cloth substrate was dipped in 10 mL of 90% (v/v) aqueous solution of glacial acetic acid for 5 hours to cause the cross-linking reaction between PVA and glutaraldehyde to occur, thus forming the chemically linked catalyst-binder hydrogel materials-based anode. After the treatment, the catalyst ink-coated carbon cloth was washed thoroughly with DI water to remove excess of impurities.

### EXAMPLE A-4

Preparation of PVA Hydrogel Membrane Electrolyte (PHME)

PVA hydrogel membrane electrolytes (PHMEs) were prepared by a solution casting method in which an optimized mixture of an aqueous solution of PVA (0.1 g mL⁻¹) and glutaraldehyde (25%), as prepared by a procedure described in Example A-2, was cast on a glass Petri dish and left at ambient conditions of temperature and pressure for ˜48 hours to allow the water to evaporate. After the evaporation of water, a dry film comprising a homogeneous mixture of PVA and glutaraldehyde was left at the bottom of the Petri dish.

A sufficient volume of 1.5 M sulfuric acid (H₂SO₄) was then added to the Petri dish so as to completely dip the dried composite film inside the acid solution. The Petri dish was covered with a piece of Para film so as to prevent evaporation of H₂SO₄ solution and left at ambient temperature for about 12 hours to allow absorption of H₂SO₄ solution by the dried polymer composite film. H₂SO₄, absorbed by the composite film, catalyzed the cross-linking reaction between PVA and glutaraldehyde, thus making the chemically linked hydrogel electrolyte materials.

Due to the absorption of H₂SO₄ solution and subsequent cross-linking reaction, the composite film turned into a solid hydrogel film, which was peeled off the surface of the Petri dish. The PHME was then taken out of the acid bath, washed with DI water and stored in DI water bath for use in direct borohydride fuel cells (DBFCs).

### COMPARATIVE EXAMPLE A-5

Pre-Treatment of Nafion®-117 Membrane Electrolyte (NME)

A Nafion®-117 membrane electrolyte (NME) was pre-treated following a multi-step procedure. Briefly, an NME piece of 6 cm×6 cm size was first heated in DI water at 80-90° C. in a water bath for 1 hour. The NME piece was then taken out of DI water and washed thoroughly with fresh DI water. In a second step, the washed NME piece was dipped in 5% (v/v) aqueous solution of H₂O₂ and heated at 80-90° C. in a water bath for 1 hour. The NME piece was then cooled and washed thoroughly with fresh DI water. Treatment with hot aqueous solution of H₂O₂ removed the organic impurities from the NME.

In a third step, the NME piece was dipped in 1.5 M aqueous solution of H₂SO₄ and heated at 80-90° C. in a water bath for 1 hour. Treatment with hot aqueous H₂SO₄ removed metallic impurities from the NME.

In a final step, the treated NME piece was cooled, washed thoroughly with fresh DI water and then stored in fresh DI water for use in DBFCs.

### EXAMPLE A-6

Electrochemical Characterization of Direct Borohydride Fuel Cells

For the electrochemical characterization of PVA chemical hydrogel (PCH) and Nafion® binders-based direct borohydride fuel cells (DBFCs), membrane electrode assemblies (MEAs) were prepared by sandwiching the cathode and anode on either side of a PHME or on a pre-treated NME. The MEAs comprising PCH as well as Nafion® binders-based electrodes and PHME as well as NME were employed to assemble various liquid-fed DBFCs.

The anode and cathode of each of the MEAs were contacted on their second surfaces with storage tanks for fuel and oxidant, respectively. The storage tanks were machined from high-density graphite blocks in which holes connecting the main tank with the MEA were provided to supply fuel and oxidant to the anode and cathode, respectively. The holes in the storage tanks, thus, helped in achieving minimum mass-polarization in the DBFCs. The free spaces between the holes in the storage tanks on both sides of the MEA made electrical contact with the electrodes. The active area of each of anode and cathode was 5.76 cm². The graphite storage tanks on both sides of the MEA were provided with electrical contacts that helped in conduction of electrical current to the external circuit.

The DBFC results were recorded in passive mode without using any peristaltic pump. This mode of DBFC operation is simple from engineering point of view and is most likely to be adopted in a practical device.

The fuel comprised an aqueous solution of 1.7 M NaBH₄ in 7.0 M NaOH and the oxidant comprised an aqueous solution of 2.5 M H₂O₂ in 1.5 M H₂SO₄. After installing the DBFC in the test station, performance evaluation studies were initiated. Galvanostatic-polarization data for various DBFCs were recorded by employing a Keithley sourcemeter (Model No.: 2425-C, 100 W SourceMeter®, USA) at ambient conditions of temperature and pressure.

### EXAMPLE A-7

Electrochemical Performance Durability Study on DBFC

Electrochemical performance durability study on the DBFC employing the PCH binder-based electrodes and the NME were tested galvanostatically by subjecting the DBFC to a constant load current density of 50 mA cm⁻² and monitoring its cell voltage as a function of time for 100 h. The durability data were recorded by employing a Keithley sourcemeter (Model No.: 2601A SourceMeter®, USA) at ambient temperature.

### DISCUSSION EXAMPLE A

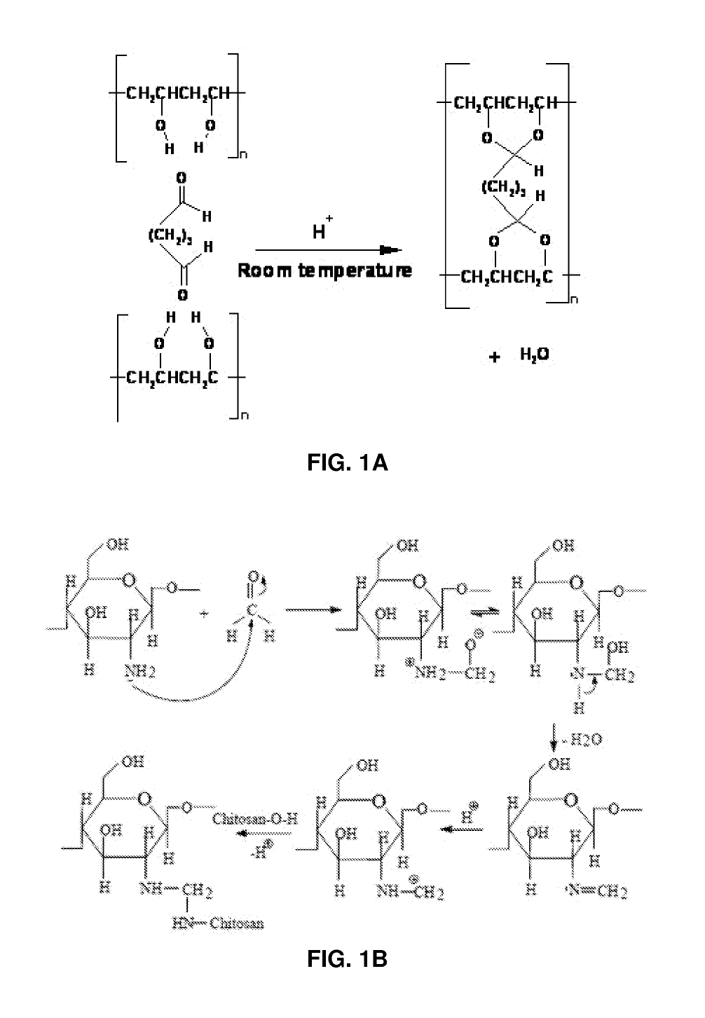

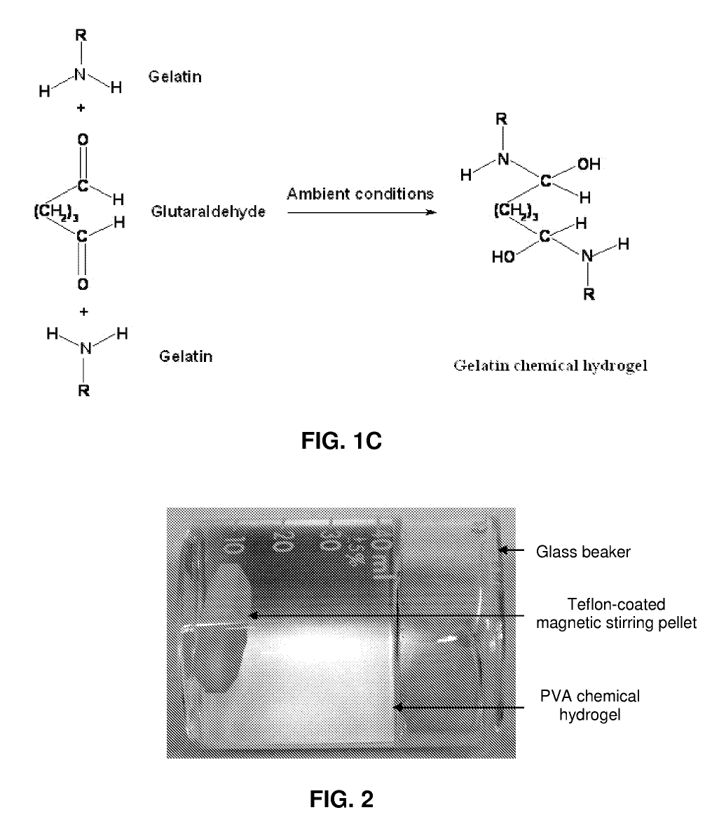

The chemical cross-linking reaction between aqueous PVA and aqueous glutaraldehyde in the presence of a protic acid catalyst leading to the formation of the chemically linked catalyst-binder hydrogel material (e.g., “PVA chemical hydrogel” (PCH)) is shown in FIG. 1A.

During the cross-linking reaction, the aqueous solutions of PVA and glutaraldehyde turn into a solid mass with all water associated with the precursor solutions remaining absorbed in the polymer matrix. The solid mass (i.e., chemically linked catalyst-binder hydrogel material) that retains all the water of PVA and glutaraldehyde solutions is generally referred to herein as a PVA chemical hydrogel (PCH).

FIG. 2 shows a chemically linked catalyst-binder hydrogel material in a glass beaker that is lying horizontally on a horizontal platform. In FIG. 2, a Teflon®-coated magnetic stirring bar that was used to mix the aqueous solutions of PVA, glutaraldehyde, and glacial acetic acid is seen stuck within the hydrogel at the bottom of the beaker. FIG. 2 clearly shows the solid nature of the chemically linked catalyst-binder hydrogel material.

FIG. 2 also illustrates how the chemically linked catalyst-binder hydrogel material binds the catalyst particles to the carbon cloth substrate in the actual electrode, while allowing transport of all water-soluble species such as ions, fuel, as well as oxidant to the catalyst surface. During the protic acid-catalyzed transformation of liquid aqueous solutions of PVA and glutaraldehyde in the presence of electrode materials into a solid mass, the electrode materials are bonded to the electrode substrate. Water absorbed in the PCH matrix during electrode fabrication help in establishing three-point contact among reactant (ion/fuel/oxidant), electrode catalyst, and the PEM.

In order to test the effectiveness of PCH as electrode binder and also to compare the effectiveness of PCH vis-à-vis Nafion® as electrode binders in DBFCs, DBFCs with four different MEAs comprising PCH binder-based electrodes and PHME, PCH binder-based electrodes and NME, Nafion® binder-based electrodes and PHME as well as Nafion® binder-based electrodes and NME were fabricated. The electrochemical performance data for all the four DBFCs have been summarized in Table 1.

TABLE 1
Summary of electrochemical data obtained from DBFCs comprising PVA
chemical hydrogel and Nafion ®-based binders and PEMs.

| | | Peak | | Total current |
|---|---|---|---|---|
| | Open | power | Current density | density |
| | circuit | density | (mA cm⁻²) | delivered by |
| DBFC | potential | (mW | corresponding | the DBFC |
| comprising | (V) | cm⁻²) | to peak power | (mA cm⁻²) |
| PCH binder-based | 1.8 | 69 | 71 | 127 |
| electrodes | | | | |
| and PHME | | | | |
| PCH binder-based | 1.9 | 75 | 75 | 137 |
| electrodes and NME | | | | |
| Nafion ® binder- | 1.8 | 79 | 80 | 158 |
| based electrodes | | | | |
| and PHME | | | | |
| Nafion ® binder- | 1.9 | 70 | 69 | 139 |
| based electrodes | | | | |
| and NME | | | | |

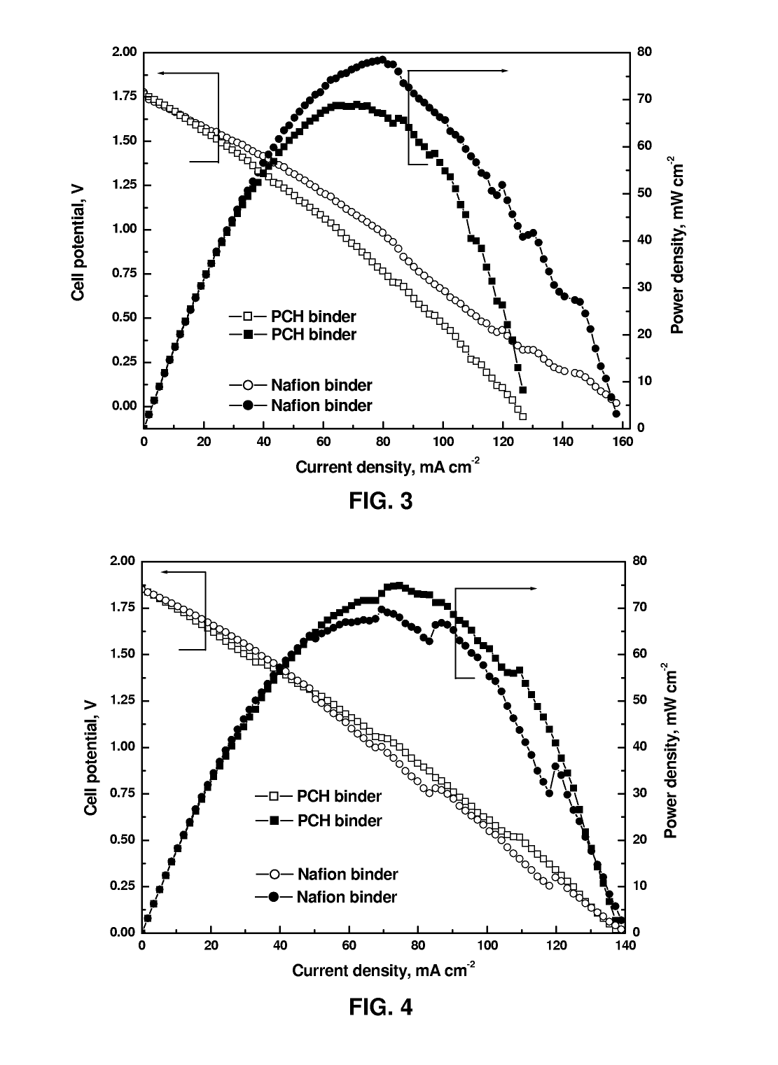

The electrochemical performance data for DBFCs employing PHME as electrolyte-cum-separator and PCH as well as Nafion® as electrode binders are shown in FIG. 3.

As shown in FIG. 3 and Table 1, open circuit potentials (OCPs) of about 1.8 V were observed for both the DBFCs. Peak power densities of about 69 and 79 mW cm⁻² at corresponding current density values of about 71and 80 mA cm⁻² were observed for DBFCs with PCH and Nafion® electrode binders, respectively.

Total current densities observed for DBFCs with PCH and Nafion® electrode binders were about 127 and 158 mA cm⁻², respectively. The electrochemical performances data for DBFCs employing NME as electrolyte-cum-separator and PCH as well as Nafion® as electrode binders are shown in FIG. 4.

As illustrated in FIG. 4 and Table 1, OCP values of about 1.9 V are observed for both the DBFCs. Peak power densities of about 75 and 70 mW cm⁻² at corresponding current density values of about 75 and 69 mA cm⁻² were observed for DBFCs with PCH and Nafion® electrode binders, respectively.

Total current densities observed for DBFCs with PCH and Nafion® electrode binders were about 137 and 139 mA cm⁻², respectively.

While not wishing to be bound by theory, the inventors herein now believe that the higher OCP values of NME-based DBFCs in contrast to those of PHME-based DBFCs may be due to the higher ionic conductivity of NME, which is an ionomer membrane containing highly dissociable sulfonic acid groups attached to its polymer backbone.

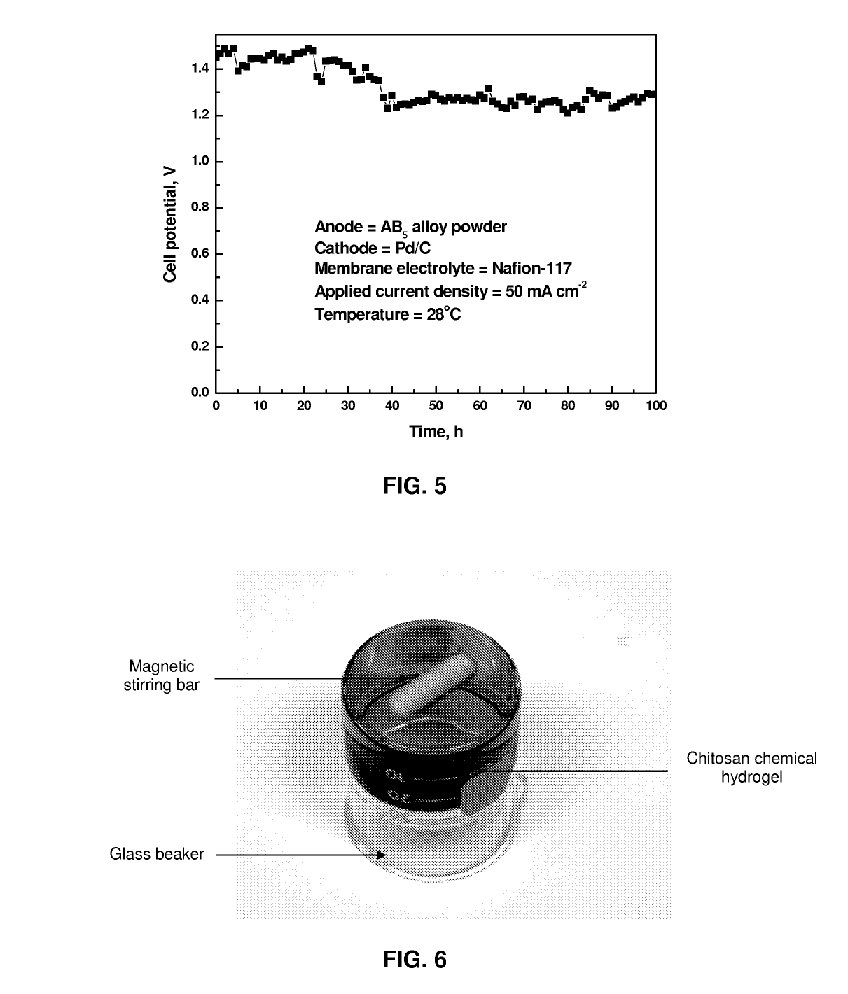

The DBFC employing Nafion® binder-based electrodes and PHME as electrolyte-cum-separator exhibited the highest power density among all the four DBFCs studied. The highest power density of the DBFC can be understood by considering the physical states of fuel as well as oxidant of the DBFCs and structural features of the electrode binders as well as the PEMs. Since all the DBFCs are operated in flooded mode with both fuel and oxidant being in liquid states, the relative water retaining capacity of the electrode binders becomes less important. Since Nafion® binder has inherent ionic conductivity in contrast to PCH binder, the ionic conductivity within electrode matrix will be higher in Nafion® binder-based electrodes than in PCH binder-based electrodes. While some might consider this a better electrochemical power performance for Nafion® binder containing electrode-based DBFC, the better power performance of DBFC employing PHME (in contrast to NME-based DBFCs) can be explained in terms of thickness and density of the PEMs. Thicknesses of PHME and NME are about 100 and 178 μm, respectively. Densities of PHME and NME are about 1.2 and 2.2 g cm⁻³, respectively. Because of the lesser values of thickness and density of PHME as compared to NME, the ohmic voltage (IR) drop across PHME will be lesser as compared to that across NME. Lesser IR drop across PHME will result in higher observed cell voltage (V) and hence higher power (I×V) density in PHME-based DBFC as compared to NME-based DBFC. The electrochemical performance durability data for DBFC employing PCH binder-based electrodes and NME as electrolyte-cum-separator is shown in FIG. 5.

The cell voltage varied between 1.4 and 1.5 V for first 20 hours of the test. During the next 20 hours, the cell voltage decreased gradually to about 1.25 V. During the subsequent 60 hours, the cell voltage varied between 1.2 and 1.3 V. The cell performance durability data observed is comparable to those for a similar DBFC although the applied current density and active area for the present DBFC are 50 mA cm⁻² and 5.76 cm², respectively in contrast to 10 mA cm⁻² and 9 cm² for the above-described DBFC.

Also, the present DBFC uses PCH as electrode binder in both anode as well as cathode and Pd/C as cathode catalyst, whereas the above-cited DBFC employed Nafion® as electrode binder on anode side and cathode was a gold-plated stainless steel mesh.

Nafion® consists of a combination of hydrophobic polymer base, hydrophilic ionic clusters and an intermediate region that allows effective ion transfer to the catalyst surface when used as electrode binder. PTFE is a highly hydrophobic electrode binder and hence is useful in mitigating flooding of cathode while allowing effective oxygen transfer to the cathode catalyst surface. However, PTFE restricts transfer of ions to the catalyst surface due to its high hydrophobic nature. In addition, water absorption and retention capabilities of pristine polymers such as Nafion® are comparatively small, thereby limiting the transfer efficiency of ion, fuel and oxidant to the electro-catalyst surface.

The large volume of water absorbed in the polymer matrix of a polymer hydrogel helps in attaining high mobility of ions, fuel and oxidant within the hydrogel-bonded electrode matrix. In addition, the polymer hydrogel binders are more efficient than pristine polymer binders in establishing and maintaining a desired three-point contact among the reactant (ion/fuel/oxidant), the electro-catalyst and the PEM.

The loading of a polymer-based binder in the electrode of a fuel cell plays an important role in delivering high electrochemical performance. The effect of Nafion® binder content in the anodes of air-breathing DBFCs on their power performances shows that the DBFC performance increases with increase in the content of Nafion® binder from 10 to 25 wt. % and then decreases with further increase in the content of Nafion® binder to 30 wt. %. The initial increase of DBFC performance with increase in the content of Nafion® electrode binder has been ascribed to the increased wet ability of the electrode mass by hydrophilic nature of Nafion® that facilitates permeation of aqueous fuel and electrolyte to the electro-catalyst surface. The decrease in DBFC performance with increase in the content of Nafion® electrode binder beyond 25 wt. % has been ascribed to the increased electrical resistance in the electrode mass due to the electrical insulator nature of Nafion®.

A similar binder content effect was observed with the PCH binder. Optimum loadings of the PCH binder in anode and cathode of DBFCs were about 5 and 20 wt. %, respectively. A lower loading of PCH binder in the anode was sufficient because the anode comprised mostly of AB₅ metallic powder that has low surface area and only 10 wt % of Vulcan XC 72® carbon powder with high surface area. A higher content of PCH binder in the cathode was used because the cathode comprised of only 10 wt. % Pd metal that has low surface area, which was supported on 90 wt. % of high surface area Vulcan XC 72® carbon powder. That is, the cathode material was fluffier than the anode material and hence needed more content of PCH binder for optimum performance in the DBFCs. It may be noted that for the same electrode materials, the content of PCH binder used was about ten times higher than that of chitosan chemical hydrogel binder. This difference may be due to the difference in the structural as well as functional characteristics of PVA that is a synthetic polymer and chitosan that is a natural polymer.

Manufacturing of PCH

When Nafion® or PTFE is employed as an electrode binder, the MEA is generally prepared by a hot-compaction technique in which the mixture of electrode material and polymer binder is heated to a temperature that is in the melting point range of the binding polymer. At the melting point, the polymer melts and while solidifying during cooling under pressure, such polymer encompasses the electrode material with the electrode substrate and PEM.

Unlike Nafion® or PTFE that act as a binder due to a physical phenomenon such as heating, the binding action of the chemically linked catalyst-binder hydrogel material PCH is due to a chemical reaction in which PVA undergoes a chemical reaction with a cross-linking reagent such as glutaraldehyde in the presence of a protic acid catalyst under ambient conditions of temperature and pressure. The binding action of PCH for the electrode mass is thus accompanied with breaking of some existing covalent bonds and formation of some new covalent bonds.

As shown in Example A herein, the PCH provides an improved and cost-effective electrode binder for use in DBFCs. In addition, the PCH is useful as an electrode binder in DBFCs in conjunction with not only a laboratory-made hydrogel membrane, namely PHME, but also a commercial ionomer membrane such as Nafion®-117 membrane.

Preparations of PCH binder-based electrodes, fabrications of PCH binder containing electrode-based MEAs and assembling of DBFCs with such MEAs are both readily manufactured and are time-effective. In addition, the use of water as suspension medium during PCH binder-based catalyst ink preparation improves cost-effectiveness and environment-friendliness of DBFCs.

### EXAMPLE B

### EXAMPLE B-1

Referring now to FIG. 1B, the chemical cross-linking reaction between aqueous chitosan and aqueous formaldehyde resulting in the formation of chitosan chemical hydrogel is shown. In another embodiment, the chemical cross-linking reaction between aqueous gelatin and aqueous glutaraldehyde resulting in the formation of gelatin chemical hydrogel is shown in FIG. 1C.

Preparation of Chitosan Chemical Hydrogel (CCH) Binder-Based Electrodes

To prepare an anode catalyst ink with the chemically linked catalyst-binder hydrogel materials, a desired amount of an AB₅ alloy (La_{10.5}Ce_{4.3}Pr_{0.5}Nd_{1.4}Ni_{60.0}Co_{12.7}Mn_{5.9}Al_{4.7}) powder (Ovonic Battery Company) was mixed with 10 wt. % Vulcan XC 72® carbon powder and adequate quantity of water in a glass vial. The vial containing the aforesaid suspension was agitated in an ultrasonic water bath (Bransonic® ultrasonic cleaner) for 2 hours.

Subsequently, a desired volume of a 2% (w/v) solution of chitosan dissolved in 1% (v/v) aqueous acetic acid, CH₃COOH, solution was added drop-wise to the aforesaid suspension with ultrasonic agitation continued for another 2 hours.

The ink for cathode catalyst, 10 wt. % Pd/C (Aldrich), was prepared in a similar way. The loadings of AB₅ in anode, palladium in cathode, and CCH binder in both the anode as well as the cathode were 30 mg cm⁻², 1 mg cm⁻², 0.5 wt. %, and 2 wt. %, respectively. The anode or cathode ink was pasted on a carbon cloth (Zorflex® Activated Carbon Cloth, FM 10, Chemviron Carbon) substrate with a paint brush and the catalyst ink-coated carbon cloth was dried inside a forced air-convection oven at room temperature. Finally, each of the dried catalyst-coated carbon cloths was separately dipped in 10 mL of 6.25% (v/v) aqueous glutaraldehyde solution for 5 hours to cause the cross-linking reaction between chitosan and glutaraldehyde to occur. After the treatment, the catalyst-coated carbon cloth was washed with de-ionized water.

### EXAMPLE B-2

Electrochemical Characterization of CCH Binder-Based DBFCs

For electrochemical characterization of DBFCs, membrane electrode assemblies (MEAs) were prepared by sandwiching PHME or NME between anode and cathode. PHME was prepared by a solution casting technique. Prior to its use in DBFCs, NME was cleaned by a pre-treatment.

MEAs comprising chitosan chemically linked catalyst-binder hydrogel material electrodes and PHME as well as NME were employed to assemble various liquid-feed DBFCs. The anode and cathode of each of the MEAs were contacted on their second surfaces with graphite storage tanks for fuel and oxidant, respectively.

The fuel comprised an aqueous solution of 1.7 M NaBH₄ in 7.0 M NaOH and the oxidant comprised an aqueous solution of 2.5 M H₂O₂ in 1.5 M H₂SO₄. All DBFC results reported were recorded in passive mode employing a Keithley sourcemeter at ambient conditions of temperature and pressure.

### DISCUSSION OF EXAMPLE B

Chitosan, dissolved in aqueous CH₃COOH solution, undergoes a chemical cross-linking reaction with aqueous glutaraldehyde at ambient temperature and pressure. Due to the reaction, aqueous solution of chitosan turns into a solid mass with all water associated with the precursor solutions remaining absorbed in the polymer matrix of the solid entity. Such a solid entity is described herein as chitosan chemically linked catalyst-binder hydrogel material.

During solidification of aqueous solutions of chitosan and glutaraldehyde in the presence of electrode materials, the electrode materials are bonded to the electrode substrate. Water absorbed in the chitosan hydrogel matrix during electrode fabrication aid in establishing and maintaining a three-point contact among the reactant (fuel/oxidant), the electro-catalyst and the PEM.

The chitosan chemically linked catalyst-binder hydrogel material is insoluble in water and does not disintegrate on heating. These characteristics of CCH make it a suitable electrode binder for DBFCs. The CCH in an inverted glass beaker is shown in FIG. 6, where a Teflon®-coated magnetic stirring bar that was used to mix solutions of chitosan and glutaraldehyde is seen stuck within the hydrogel at the bottom of the beaker.

FIG. 6 clearly shows the solid nature of CCH. FIG. 6 also illustrates how the electrode materials are held within the hydrogel and bound to the carbon cloth substrate in the actual electrode, while allowing transport of any water-soluble species such as ion, fuel or oxidant to the catalyst. As shown in FIG. 6, the chitosan chemical hydrogel is transparent and brown in color.

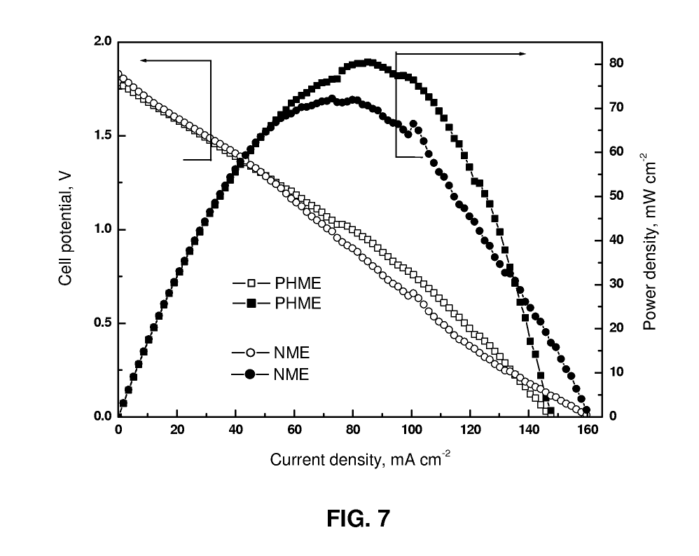

The electrochemical performance data for DBFCs employing CCH as electrode binder and PHME, as well as NME, as electrolytes-cum-separators are shown in FIG. 7.

The graphs in FIG. 7 show that open circuit voltages (OCVs) of about 1.8 V are observed for both the DBFCs.

Peak power densities of about 81 and 72 mW cm⁻² have been observed at corresponding current density values of about 85 and 73 mA cm⁻² for DBFCs employing PHME and NME, respectively.

Total current densities achieved from DBFCs with PHME and NME are about 148 and 160 mA cm⁻², respectively.

The higher power density of PHME-based DBFC as compared to NME-based DBFC can be explained in terms of thickness and density of the membrane electrolytes.

Thicknesses of PHME and NME are about 100 and 178 μm, respectively. Densities of PHME and NME are 1.2 and 2.2 g cm⁻³, respectively. Because of the lesser values of thickness and density of PHME as compared to NME, the ohmic voltage (IR) drop across PHME will be lesser as compared to that across NME. Lesser IR drop across PHME will result in higher observed cell voltage (V) and hence higher power (I×V) density in PHME-based DBFC as compared to NME-based DBFC.

The better performance of NME-based DBFC as compared to PHME-based DBFC in terms of total current density achieved is illustrated by considering the structural features of the two membranes and extent of BH₄⁻ fuel crossover across them. PHME is a nonionic membrane whereas NME is an ionomer membrane with negatively charged —SO₃⁻ groups attached to the Nafion® backbone. Being a negatively charged ion, BH₄⁻ will experience a repulsive force while crossing over through NME.

In contrast, crossing over of BH₄⁻ across PHME will not have such a hindering effect. Because of these contrasting behaviors of NME and PHME towards crossover of BH₄⁻ from anode to cathode, the extent of loss of BH₄⁻ fuel from anode compartment of NME-based DBFC will be lesser than that in PHME-based DBFC. This means that the NME-based DBFC will have more net amount of fuel in anode compartment as compared to PHME-based DBFC. Availability of more quantity of fuel leads to delivery of more current density in NME-based DBFC as compared to PHME-based DBFC.

The electrochemical performances of DBFCs employing CCH binder-based electrodes and PHME as well as NME as separators have been studied for a period spanning over seven days; the pertinent data are summarized in Table 2.

TABLE 2
Electrochemical performance durability data for DBFCs employing
CCH electrode binder and PHME as well as NME as separators.

| | Open circuit voltage | | Peak power density | | Current density (mW cm⁻²) | |
|---|---|---|---|---|---|---|
| | (V) | | (mW cm⁻²) | | corresponding to peak power | |
| Characterization | DBFC | DBFC | DBFC | DBFC | DBFC | DBFC |
| of DBFC on | with PHME | with NME | with PHME | with NME | with PHME | with NME |
| Day - 1 | 1.8 | 1.8 | 69 | 72 | 73 | 73 |
| Day - 7 | 1.8 | 1.8 | 81 | 69 | 85 | 73 |

The OCV values for both the DBFCs remain stable at 1.8 V over the aforesaid duration. Peak power density and current density corresponding to peak power of PHME-based DBFC increased significantly while those of NME-based DBFC remained almost constant over the aforesaid time period. While not wishing to be bound by theory, the inventors herein now believe that the improvement in peak power density and current density corresponding to peak power of PHME-based DBFC may be due to the decreased electrode/electrolyte interfacial resistance resulting from development of better adhesion between chemical hydrogel based PEM and electrode binder. During the characterization of each of the DBFCs spanning over seven days, the electrodes were found to be stable and intact, indicating good binding action of CCH.

Manufacturing of CCH

When Nafion® or PTFE is employed as electrode binder, MEA fabrication is done by hot compaction where the polymer melts during heating and while solidifying during cooling, it encompasses the electrode material and binds it to the electrode substrate.

In contrast, the binding action of CCH is due to a chemical reaction between chitosan and glutaraldehyde at ambient temperature and pressure. Nafion® binder is costly whereas CCH binder, which can be prepared in-house, is inexpensive to manufacture.

Catalyst inks with Nafion® binder are generally prepared in 2-propanol. Such use of organic solvents not only adds to cost of fuel cell technology, but also cause health and environmental hazards. In contrast, catalyst inks with CCH binder are prepared with water as the suspension medium, thereby enhancing cost-effective and environmentally safe technologies.

As shown in Example B herein, the CCH provides an improved and cost-effective electrode binder for use in DBFCs. In addition, CCH can be employed as an electrode binder in DBFCs in conjunction with not only a laboratory-made hydrogel membrane, namely PHME, but also a commercial membrane such as Nafion®-117 membranes. Fabrications of CCH binder-based electrodes, MEAs and assembling of DBFCs with such MEAs are both easy and time-effective.

The DBFCs employing PHME and NME exhibited peak power density values of about 81 and 72 mW cm⁻² at corresponding current density values of about 85 and 73 mA cm⁻², respectively.

Total current densities achieved from DBFCs with PHME and NME are about 148 and 160 mA cm⁻², respectively.

Another important discovery by the co-inventors herein is that, for a given amount of a certain electrode material, the required loading of chitosan chemically linked catalyst-binder hydrogel material is low as compared to PVA chemically linked catalyst-binder hydrogel material.

### EXAMPLE C

### Examples of Fuel Cells, Uses and Advantages

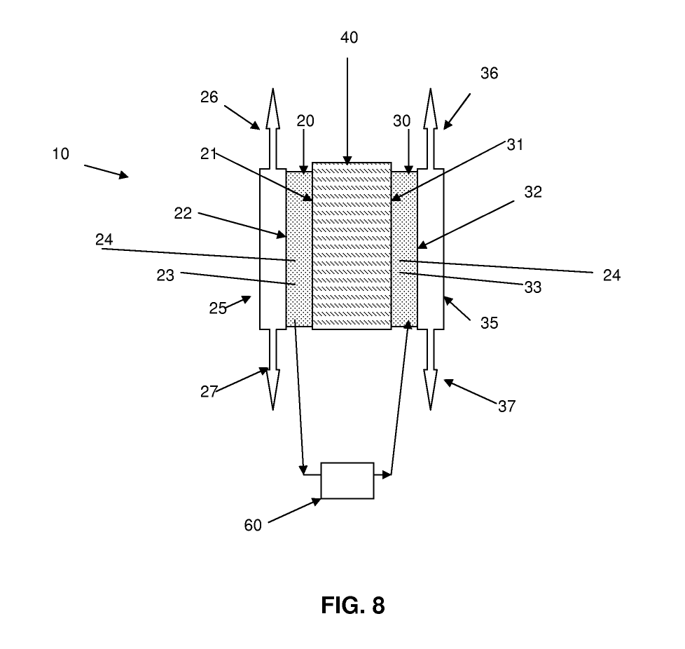

Referring now to FIG. 8, there is illustrated a fuel cell 10 having an anode 20, a cathode 30 and an electrolyte 40 between the anode 20 and the cathode 30. It is to be understood that, depending on the type of fuel cell, the electrolyte may be a liquid electrolyte or a solid electrolyte.

During use of the fuel cell 10, fuel in the gas and/or liquid phase is in contact with the anode 20 where the fuel is oxidized by an anode catalyst 24 to produce protons and electrons in the case of hydrogen fuel, or protons, electrons, and carbon dioxide in the case of an organic fuel. The electrons flow through an external load, or circuit, 60 to the cathode 30.

Also occurring during use of the fuel cell 10, an oxidant (such as air, oxygen, or an aqueous oxidant (e.g., peroxide) is in contact with the cathode 30. The protons that are produced at the anode 20 travel through electrolyte 40 to the cathode 30, where the oxidant (e.g., oxygen) is reduced in the presence of the protons and the electrons, thus producing a by-product (e.g., aqueous and/or vaporous water).

In the embodiment illustrated in FIG. 8, the anode 20 has first surface 21 and second surface 22. The anode 20 is comprised of a substrate 23 where at least the first surface 21 is at least partially coated/impregnated with a chemically linked catalyst-binder hydrogel material 24.

Thus, the first surface 21 of the anode 20 is in contact with the electrolyte 40. The second surface 22 of anode 20 may be in contact with a fuel channel 25. In the illustrated embodiment, a desired quantity and type of fuel flows through the fuel channel 25 from a fuel inlet 26 and to a fuel outlet 27. In other embodiments, the fuel can be in both the fuel channel 25 and need not flow out of the channel 25. In still other embodiments, the fuel can be in both the fuel channel 25 and in the electrolyte 40.

Similarly, in the embodiment illustrated in FIG. 8, the cathode 30 has first surface 31 and second surface 32. The cathode 30 is comprised of a substrate 33 where at least the first surface 31 is at least partially coated/impregnated with a cathode catalyst ink containing the chemically linked catalyst-binder hydrogel material 34.

Thus, the first surface 31 of the cathode 30 is in contact with the electrolyte 40. The second surface 32 of cathode 30 is in contact with an oxidant channel 35. In the illustrated embodiment, the oxidant channel 35 has an inlet 36 and an outlet 37.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiment disclosed herein contemplated for carrying out this invention, but that the invention will include all embodiments falling within the scope of the claims.

1. A fuel cell comprising:
an anode, a cathode, and an electrolyte between the anode and the cathode,
the anode having a first surface and second surface, the anode being comprised of a substrate where at least the first surface of the anode substrate is at least partially coated and/or impregnated with a first chemically linked catalyst-binder hydrogel material;
the cathode having a first surface and a second surface, the cathode being comprised of a substrate where at least the first surface of the cathode substrate is at least partially coated and/or impregnated with a second chemically linked catalyst-binder hydrogel material.

2. The fuel cell of claim 1, wherein the first chemically linked catalyst-binder hydrogel material that is capable of binding an anode catalyst material to the anode substrate; and wherein
the second chemically linked catalyst-binder hydrogel material is capable of binding a cathode catalyst material to the cathode substrate.

3. The fuel cell of claim 1, wherein the first surface is at least partially coated an/or impregnated with a first anode ink comprising an anode catalyst, an anode catalyst support material such as high surface area carbon powder and the first chemically linked catalyst-binder hydrogel material; and/or
wherein at least the first surface of the cathode substrate is at least partially coated and/or impregnated with a second cathode ink comprising a cathode catalyst, a cathode catalyst support material such as high surface area carbon powder, and the second chemically linked catalyst-binder hydrogel material.

4. The fuel cell of claim 1, wherein chemically linked catalyst-binder hydrogel material is prepared by chemical cross-linking of at least one type of polymer that is soluble in aqueous acetic acid or water with a water-soluble cross-linking agent.

5. The fuel cell of claim 1, 2, 3 or 4, wherein the fuel cell comprises a direct borohydride fuel cell.

6. The fuel cell of claim 1, wherein the anode has been formed by:
i) providing an aqueous suspension comprised of an anode catalyst;
ii) providing an aqueous mixture of a polymer and a cross-linking agent;
iii) adding the mixture of ii) to the suspension of i) to form an anode catalyst ink;
iv) at least partially coating the substrate with the anode catalyst ink of iii); and,
v) exposing the coated substrate of iv) to a protic acid catalyst that is capable of causing cross-linking of the polymer with the cross-linking agent such that the first chemically linked catalyst-binder hydrogel material is formed;
wherein the anode catalyst is at least partially contained within the chemically linked catalyst-binder hydrogel material.

7. The anode of claim 6, wherein the anode catalyst comprises AB₅ alloy and carbon powder, the polymer comprises PVA, the cross-linking agent comprises glutaraldehyde, and the protic acid catalyst comprises one or more of: HCl, HClO₄, H₂SO₄, HClO₃ or CH₃COOH.

8. The fuel cell of claim 1, wherein the cathode has been formed by:
i) providing an aqueous suspension comprised of a cathode catalyst;
ii) providing an aqueous mixture of a polymer and a cross-linking agent;
iii) adding the mixture of ii) to the suspension of i) to form a cathode catalyst ink;
iv) at least partially coating the substrate with the cathode catalyst ink of iii); and,
v) exposing the coated substrate of iv) to a protic acid catalyst that is capable of causing cross-linking of the polymer with the cross-linking agent such that the second chemically linked catalyst-binder hydrogel material is formed;
wherein the cathode catalyst is at least partially contained within the second chemically linked catalyst-binder hydrogel material.

9. The cathode of claim 8, wherein the cathode catalyst comprises carbon-supported palladium (Pd/C), the polymer comprises PVA, the cross-linking agent comprises glutaraldehyde, and the protic acid catalyst comprises one or more of: HCl, HClO₄, H₂SO₄, HClO₃ or CH₃COOH.

10. The fuel cell of claim 6 or 8, wherein the cross-linking reaction takes place at ambient conditions of temperature and pressure.

11. The fuel cell of claim 1, wherein the anode has been formed by:
i) providing an aqueous suspension comprised of an anode catalyst;
ii) providing a solution of chitosan dissolved in an aqueous protic acid;
iii) adding the solution of ii) to the suspension of i) to form an anode catalyst ink;
iv) at least partially coating the substrate with the anode catalyst ink of iii); and,
v) exposing the coated substrate of iv) to an aqueous solution of a cross-linking agent, wherein chitosan is cross-linked with the cross-linking agent such that the first chemically linked catalyst-binder hydrogel material is formed;
wherein the anode catalyst is at least partially contained within the first chemically linked catalyst-binder hydrogel material.

12. The anode of claim 11, wherein the anode catalyst comprises AB₅ alloy and carbon powder, and the cross-linking agent comprises glutaraldehyde.

13. The fuel cell of claim 1, wherein the cathode has been formed by:
i) providing an aqueous suspension comprised of a cathode catalyst;
ii) providing a solution of chitosan dissolved in an aqueous protic acid;
iii) adding solution of ii) to the suspension of i) to form a cathode catalyst ink;
iv) at least partially coating the substrate with the cathode catalyst ink of iii); and,
v) exposing the coated substrate of iv) to an aqueous solution of a cross-linking agent, wherein chitosan is cross-linked with the cross-linking agent such that the second chemically linked catalyst-binder hydrogel material is formed;
wherein the cathode catalyst is at least partially contained within the second chemically linked catalyst-binder hydrogel material.

14. The cathode of claim 13, wherein the cathode catalyst comprises carbon-supported palladium (Pd/C), and the cross-linking agent comprises glutaraldehyde.

15. The fuel cell of claim 11 or 13, wherein the cross-linking reaction takes place at ambient conditions of temperature and pressure.

16. The fuel cell of claim 1, wherein at least one of the anode substrate and cathode substrate are comprised of a carbon paper or carbon cloth.

17. A method of generating electricity comprising the fuel cell of claim 1.

18. A power supply device comprising the fuel cell of claim 1.

19. A fuel cell comprising:
an anode, a cathode, and an electrolyte between the anode and the cathode,
the anode having a first surface and second surface, the anode being comprised of a substrate where at least the first surface of the anode substrate is at least partially coated and/or impregnated with a first chemically linked catalyst-binder hydrogel material that encompasses the anode catalyst;
the cathode having a first surface and a second surface, the cathode being comprised of a substrate where at least the first surface of the cathode substrate is at least partially coated and/or impregnated with a second chemically linked catalyst-binder hydrogel material that encompasses the cathode catalyst; and
the electrolyte comprising a mixture of a polymer and a crosslinking agent which has been exposed to an acid catalyst that is capable of causing cross-linking of the polymer with the cross-linking agent such that a chemically linked hydrogel electrolyte material is formed.

20. A chemically linked catalyst-binder hydrogel material, prepared by chemical cross-linking a polymer in aqueous medium and a water-soluble cross-linking agent that is catalyzed by a protic acid.

21. The material of claim 21, wherein the polymer comprises PVA, the water-soluble cross-linking agent comprises glutaraldehyde, and the protic acid catalyst comprises one or more of: HCl, HClO₄, H₂SO₄, HClO₃ or CH₃COOH.

22. A material comprising a PVA chemically linked catalyst-binder hydrogel material that is stable in acidic environments.

23. Use of the chemically linked catalyst-binder hydrogel material of claim 22 in fuel cells that employ an acidic environment.

24. A material comprising a PVA chemically linked catalyst-binder hydrogel material that is stable in alkaline environments.

25. Use of the chemically linked catalyst-binder hydrogel material of claim 24 in fuel cells that employ an alkaline environment.

26. The material of claim 18, wherein the polymer comprises chitosan dissolved in aqueous acetic acid and the water-soluble cross-linking agent comprises glutaraldehyde.

27. A material comprising a chitosan chemically linked catalyst-binder hydrogel material that is stable in acidic environments.

28. Use of the chemically linked catalyst-binder hydrogel material of claim 27 in fuel cells that employ an acidic environment.

29. A material comprising a chitosan chemically linked catalyst-binder hydrogel material that is stable in alkaline environments.

30. Use of the chemically linked catalyst-binder hydrogel material of claim 29 in fuel cells that employ an alkaline environment.

31. A method of making a chemically linked catalyst-binder hydrogel material, comprising:
cross-linking a polymer in aqueous medium with an aqueous cross-linking agent in the presence of an aqueous protic acid catalyst under ambient conditions of temperature and pressure.

32. The method of claim 31, comprising: cross-linking PVA in an aqueous solution of acetic acid with aqueous glutaraldehyde cross-linking agent under ambient conditions of temperature and pressure.

33. The method of claim 31, comprising: cross-linking chitosan in an aqueous solution of acetic acid with aqueous glutaraldehyde cross-linking agent under ambient conditions of temperature and pressure.

34. A chemically linked hydrogel electrolyte material, comprising:
a mixture of a polymer and a crosslinking agent, which has been exposed to an acid catalyst that is capable of causing cross-linking of the polymer with the cross-linking agent such that the chemically linked hydrogel electrolyte material is formed.

35. The electrolyte material of claim 34, wherein the polymer comprises one or more of PVA, chitosan, gelatin, the cross-linking agent comprises glutaraldehyde, and the protic acid catalyst comprises one or more of: HCl, HClO₄, H₂SO₄, and HClO₃.

36. A method for making a chemically linked hydrogel electrolyte material, comprising:
i) providing a mixture of a polymer and a crosslinking agent;
ii) forming a film from the mixture of i);
iii) exposing the film of ii) to an acid catalyst that is capable of causing cross-linking of the polymer and the cross-linking agent such that the chemically linked hydrogel electrolyte membrane material is formed;
wherein the anode catalyst is at least partially contained within the chemically linked catalyst-binder hydrogel material.

37. The electrolyte material of claim 36, wherein the polymer comprises PVA, the cross-linking agent comprises glutaraldehyde, and the protic acid catalyst comprises one or more of: HCl, HClO₄, H₂SO₄, and HCl₃.

38. An electrochemical energy storage device having: a positive electrode, a negative electrode, and an electrolyte between the positive electrode and the negative electrode, and a chemically linked hydrogel as an electrode binder.

39. The device of claim 38, comprising a battery that employs either aqueous acidic and alkaline media.

40. An electrochemical supercapacitor having: two similar electrodes, and an electrolyte between the two electrodes.
wherein each of the two electrodes is comprised of a substrate that has a first surface and a second surface,
at least the first surface of each of the substrate is at least partially coated and/or impregnated with an electrode material that comprises a high surface area material and a chemically linked catalyst-binder hydrogel material.

41. An electrochemical supercapacitor having: two dissimilar electrodes, and an electrolyte between the two electrodes,
wherein each of the two electrodes is comprised of a substrate that has a first surface and a second surface,
at least the first surface of each of the substrates is at least partially coated and/or impregnated with an electrode material that comprises a high surface area material and a chemically linked catalyst-binder hydrogel material.

42. The supercapacitor of claim 40 or 41, wherein the high surface area material comprises one or more of activated carbons, aerogels, xerogel carbons, and carbon nanotubes.

43. The supercapacitor of claim 40 or 41, wherein the electrode material comprises an electro-active material and a chemically linked catalyst-binder hydrogel material.

44. An electrochemical supercapacitor having: two similar electrodes, and an electrolyte between the two electrodes,
wherein each of the two electrodes is comprised of a substrate that has a first surface and a second surface,
at least the first surface of each of the substrates is at least partially coated and/or impregnated with an electrode material that comprises an electro-active material and a chemically linked catalyst-binder hydrogel material.

45. An electrochemical supercapacitor having: two dissimilar electrodes, and an electrolyte between the two electrodes,
wherein each of the two electrodes is comprised of a substrate that has a first surface and a second surface,
at least the first surface of each of the substrates is at least partially coated and/or impregnated with an electrode material that comprises an electro-active material and a chemically linked catalyst-binder hydrogel material.

46. The electrochemical supercapacitor of claim 44 or 45, wherein the electro-active material comprises one or more of conducting polymers and metal oxides.

47. A semi-fuel cell comprised of an anode that is capable of electro-oxidation giving rise to electrons and ionic by-product; and a cathode comprised of a substrate that has a first surface and a second surface,
wherein at least the first surface of the cathode substrate is at least partially coated and/or impregnated with an electro-active material that is capable of electrochemically reducing hydrogen peroxide.

48. A semi-fuel cell comprised of an anode that is capable of electro-oxidation giving rise to electrons and ionic by-product; and a cathode comprised of an electro-catalyst and a chemically linked catalyst-binder hydrogel material.
